(19) United States
(12) Patent Application Publication
(10) Pub. No.: US 2009/0046097 A1
(43) Pub. Date: Feb. 19, 2009

(54) Method of making animated video

(76) Inventor: Scott Barrett Franklin, Los Angeles, CA (US)

Correspondence Address: DAVID AND RAYMOND PATENT FIRM, 108 N. YNEZ AVE., SUITE 128, MONTEREY PARK, CA, 91754, US

(21) Appl. No.: 12/228,145

(22) Filed: Aug. 8, 2008

Related U.S. Application Data
(60) Provisional application No. 60/964,321, filed on Aug. 9, 2007.

(51) Int. Cl. G06T 15/70; G06T 13/00

(52) U.S. Cl. 345/419; 345/473; 345/474

(57) ABSTRACT

A method of making an animated movie includes the steps of casting one or more animated characters as performers in a play of the animated video; creating one or more scenes of the animated video; canvassing the animated character in the scene to form a motion picture, and outputting the motion picture in a realtime playback manner. The motion picture is canvassed by the steps creating a timeline of the scene; setting a light effect of the scene; setting a shooting angle of the animated character in the scene; and setting a movement of the animated character in the scene in responsive to the timeline.

### BACKGROUND OF THE PRESENT INVENTION

1. Field of Invention

The present invention relates to a method of filmmaking, and more particularly to a method of making an animated video through a computer to make the goal attainable by a single user who has minimum budget or crew at all.

2. Description of Related Arts

A huge amount of money is invested into movie industry every year to satisfy the fast growing demand of movies. Furthermore, DV has become a necessary part of human life, because DV is portable, and even has been incorporated into cell phone. With the popularity of the DV and internet, everybody has a chance to make film of his own, and shares it with the rest of the world through internet, such as “You Tube”, Blog and so on. Enterprises also make an introduction film to be introduced to the world.

Everybody knows that filmmaking has always been a very expensive artistic medium that requires a large team of people working together towards a common goal. When one tries to make a film, long or short, no matter he is expert from a big film company or a group of ordinary film making lover, one should prepare a proper scene for the film, such as surrounding buildings, light direction, camera, or even the actor's dress and so on to see if these components are suitable for this film, which would cost a lot time and energy of in many people.

One way to perfectly solve this problem is to simulating the actors and the scene on computer. There are programs on the market such as “3D Studio Max”, “Maya” and “Lightwave” that encompass the full range of modeling and three dimensional computer imaging. The programs have complex steps to make a 3D film, and do not have easy way to move the character around in 3D scene. Moreover, these programs do not provide 3D vision effect during 3D filmmaking. Therefore these programs require a great deal of time and schooling to even begin. In other words, it is extremely difficult for a beginner to use such professional software to create a short film or a movie clip.

Poser is another program that deals with Computer Graphic. The focus of Poser is not on modeling or filmmaking, the most challenging aspect of the others, but on moving characters around.

### SUMMARY OF THE PRESENT INVENTION

A main object of the present invention is to provide a method of making an animated video that a CG novice could pick up easily.

Another object of the present invention is to provide a method of making an animated video through a computer to make the goal attainable by a single user who has minimum budget or crew at all.

Another object of the present invention is to provide a method of making an animated video with a space controller to moving a target object around in 3D scene in computer.

Another object of the present invention is to provide a method of making an animated video with anaglyph 3D glasses to see a 3D scene in computer.

Another object of the present invention is to provide a method of making an animated video by software on computer.

Another object of the present invention is to provide a method of providing means to make 3D animated video directly from internet.

Accordingly, in order to accomplish the above object, the present invention provides a method of making an animated movie, comprising the steps of:

(a) casting one or more animated characters as performers in a play of the animated video;

(b) creating one or more scenes of the animated video, wherein the scene is populated with props;

(c) canvassing the animated character in the scene to form a motion picture, comprising the steps of:

(c.1) creating a timeline of the scene;

(c.2) setting a light effect of the scene;

(c.3) setting a shooting angle of the animated character in the scene, wherein the scene is viewed from the shooting angle through the timeline; and

(c.4) setting a movement of the animated character in the scene in responsive to the timeline; and

(d) outputting the motion picture in a realtime playback manner.

The present invention further provides an animated video making system, comprising:

a central database containing a casting database containing a plurality of animated characters to be selected as a performer in a play of an animated video, a scene database containing a plurality of scenes to be selectively created for the animated video and a plurality of props to be selected to populate the scene with the props, and a wardrobe database containing a plurality of costumes to be selected for costuming the animated character such that the animated character is outfitted in the scene;

a canvassing processor operatively canvassing the animated character in the scene to form a motion picture, wherein the canvassing processor comprises a timeline setter creating a timeline of the scene, a lighting setter setting a light effect of the scene, a camera selector selectively setting a shooting angle of the animated character in the scene, and a movement setter setting a movement of the animated character in the scene in responsive to the timeline; and

a rendering processor outputting the motion picture in a realtime playback manner.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram illustrating a method of making an animated video according to a preferred embodiment of the present invention.

FIG. 2 is a block diagram illustrating the animated video making system according to the above preferred embodiment of the present invention.

FIG. 3 illustrates the casting step of the animated character according to the above preferred embodiment of the present invention.

FIG. 4 illustrates the “plastic surgeon” step for modifying the animated character according to the above preferred embodiment of the present invention.

FIG. 5 illustrates the wardrobe step with props selection according to the above preferred embodiment of the present invention.

FIG. 6 illustrates the scene selection according to the above preferred embodiment of the present invention.

FIG. 7 illustrates the light effect selection according to the above preferred embodiment of the present invention.

FIG. 8 illustrating the setting set of light effect according to the above preferred embodiment of the present invention.

FIG. 9A illustrates movement setting according to the above preferred embodiment of the present invention.

FIGS. 9B and 9C illustrates the animated character controlled by manually dragging the body part according to the above preferred embodiment of the present invention.

FIG. 9D illustrates an alternative mode of the movement setting according to the above preferred embodiment of the present invention, illustrating the animated character selected by motion-captured movement library.

FIG. 10 illustrates the camera selection according to the above preferred embodiment of the present invention.

FIGS. 11A to 11D illustrate the steps of selecting different shooting angles from different camera according to the above preferred embodiment of the present invention.

FIG. 12 illustrates the input of the dialog and timeline edit according to the above preferred embodiment of the present invention.

FIG. 13 illustrates the canvas of the animated video according to the above preferred embodiment of the present invention.

FIG. 14 illustrates the render helper of the animated video making system according to the above preferred embodiment of the present invention.

FIG. 15 illustrates the stereoscopic output of the animated video according to the above preferred embodiment of the present invention.

FIG. 16 illustrates the function of “directors viewfinder” of the animated video making system according to the above preferred embodiment of the present invention.

### DETAILED DESCRIPTION OF THE PREFERRED EMBODIMENT

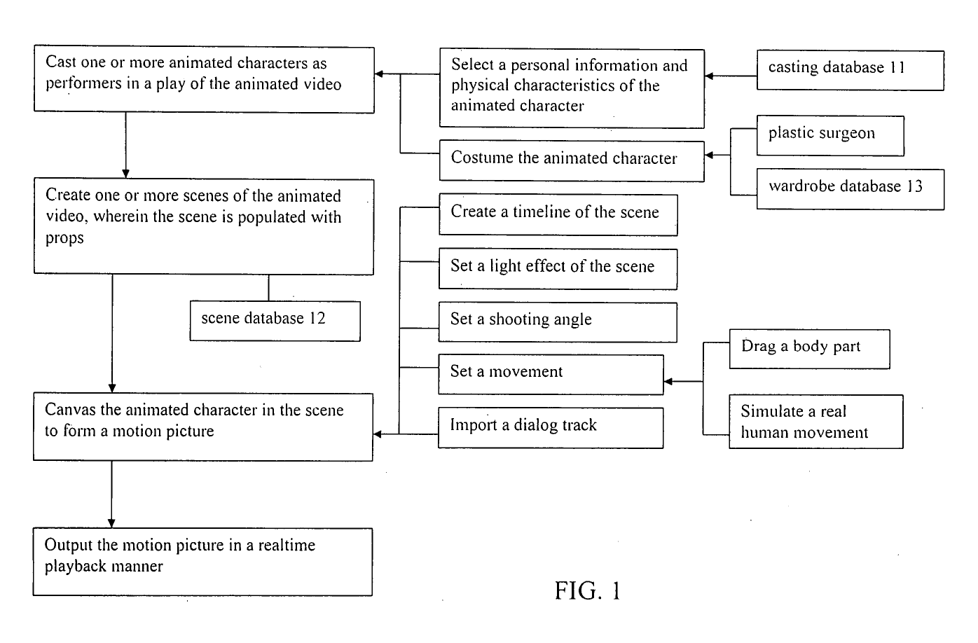

Referring to FIG. 1 of the drawings, a method of making an animated video according to a preferred embodiment of the present invention is illustrated, wherein the method comprises the following steps.

(1) Cast one or more animated characters as performers in a play of the animated video.

(2) Create one or more scenes of the animated video, wherein the scene is populated with props.

(3) Canvas the animated character in the scene to form a motion picture.

(4) Output the motion picture in a realtime playback manner on a screen.

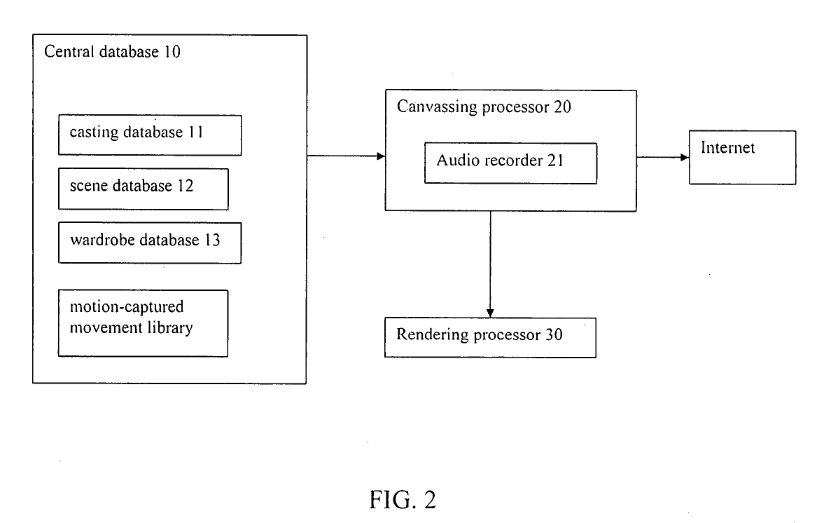

The present invention further comprises an animated video making system which comprises a central database 10, a canvassing processor 20, and a rendering processor 30, as shown in FIG. 2.

According to the preferred embodiment, the central database 10, which is a digital storage, comprises a casting database 11 containing a plurality of animated characters to be selected as a performer in a play of an animated video, a scene database 12 containing a plurality of scenes to be selectively created for the animated video and a plurality of props to be selected to populate the scene with the props, and a wardrobe database 13 containing a plurality of costumes to be selected for costuming the animated character such that the animated character is outfitted in the scene.

A 3D controller of the present invention is a manual inputting controller as a “SpacePilot” controller to controllably input all features of the animated video. For example, the 3D controller is adapted to control the view of the 3-dimensional scene and to control the timeline of the scene.

Accordingly, the step (1) further comprises the following steps.

(1.1) Select a personal information and physical characteristics of the animated character including name, age, gender, race, hair style and color, eye color, height, weight, and body shape, wherein the animated character is envisioned to be an exact person. Accordingly, two or more physical characteristics of the animated character are morphed to blend the physical characteristics together for the animated character.

(1.2) Costume the animated character wherein the animated character is outfitted in the scene.

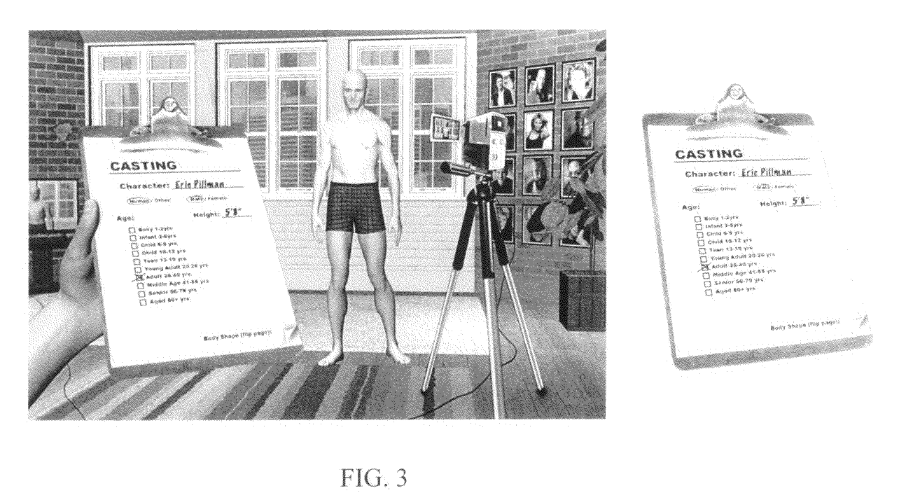

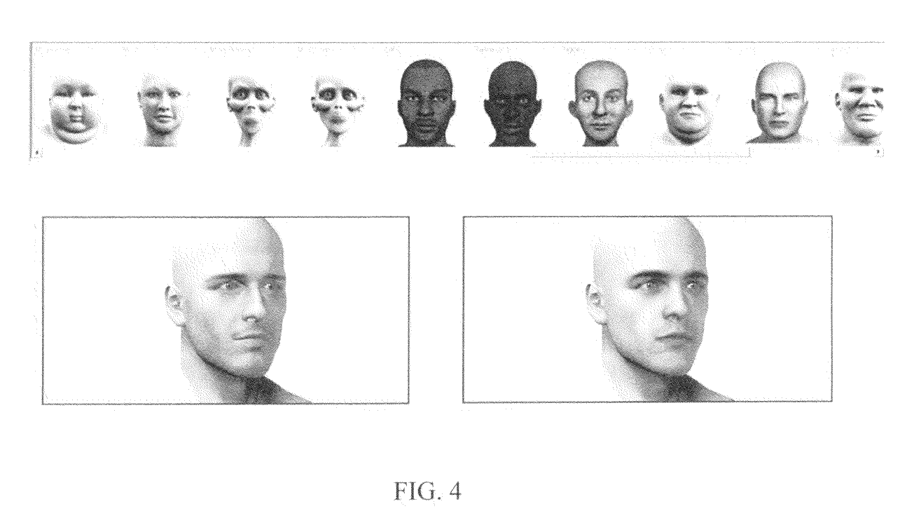

As shown in FIG. 3, the user is able to have the choice of choosing a male or female in the casting database 11 that the user then morph into the exact person he or she has in mind. The user is able to name the animated character and is able to select age, height, weight, body shape, etc. The user is also able to have a “plastic surgeon” standing by to shape the face any way he or she please. The user may physically shape the face using dials or sliders, click through a batch of randomly generated faces, or select from a list of pre-made faces, as shown in FIG. 4. Therefore, the animated character will become whoever the user can envision for the actor he or she need.

When the animated character is selectively created, the animated character is then digitally saved in a “cast trailer”. The user may then call on a new “puppet” to create the next animated character he or she need and continue this process until the cast of the animated character is filled out.

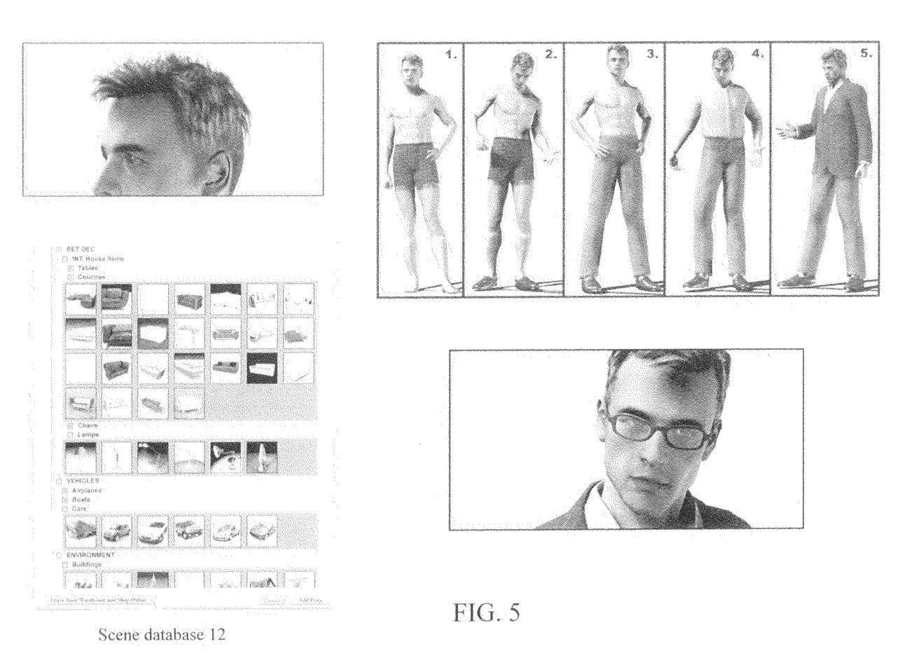

Then, the user is able to access the wardrobe database 13 as a “wardrobe trailer” with a large selection of costumes that the user may outfit the animated character in for the first scene, as shown in FIG. 5. Any animated character that was created in the previous phase may be called from the cast trailer and dressed here.

If the user is unable to find suitable clothing for the animated characters in the wardrobe trailer, the user is able to shop online for alternatives through Internet. A great deal of compatible third party materials will be available to be used with the present invention. Part of this resource will come from repurposing the massive 3D libraries from videogame companies to be importable into the present invention format. This repurposing will cover not only clothing, but props, environments and so on.

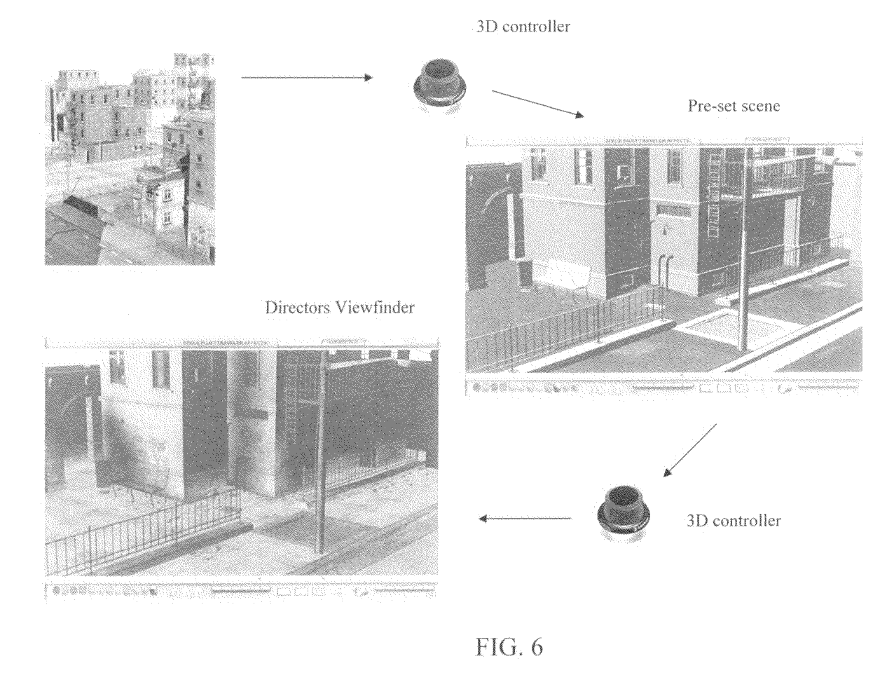

After the animated character is selected and dressed, the user is able to create the set for the first scene takes place in this workspace as shown in FIG. 6. The user will be presented with a list of areas that can be dropped into the space through the scene database 12. This list will be derived from several sources. The scene database 12 will have several environments to choose from: alleyways, city streets, arctic tundra, cowboy towns, etc. Each of these environments will be modular and editable and then able to be re-saved in new configurations. While the present invention is not a 3D modeling program, the user will have plenty of control over placing per-made objects, buildings, fences, etc. to create the environment. As well, online availability of set pieces will play a big part in setting the scene. In the case of a filmmaker needing something created wholly original for the movie, a resource of 3D designers can be hired. A filmmaker can describe what he needs to freelance 3D artist and purchase a new item as a one off. This sort of practice will be more expensive than buying something from a public library store, but once complete, the 3D artist can then make that item available to others. It the item created is of enough value to the filmmaker to keep secret, then he may opt to buy it exclusively. Again, more expensive because the 3D artist can no longer receive income from one of his or her models on the open market.

In addition, the user will also populate the scene with props through the scene database 12. The scene database 12 will provide a good selection of all sorts of props, such as vehicles, weapons, etc. The user may also go online to enjoy a wide selection of compatible 3D objects. Genre sets will be available. Videogame libraries would be made available to purchase as a unit. For example, when the user wants to make a war picture, he or she would buy the “Call of Duty” or “WW2 set” through Internet.

Once the scene is set, the user is able to place the animated character in the scene. The user can bring out as many animated characters as needed from the cast trailer. The user can even bring out several of the same animated character, if the scene calls for it.

The step (3) of the present invention further comprises the following steps.

(3.1) Create a timeline of the scene.

(3.2) Set a light effect of the scene.

(3.3) Set a shooting angle of the animated character in the scene, wherein the scene is viewed from the shooting angle through the timeline. Accordingly, the shooting angle is selected by at least one of a handheld/stedicam mode, a dolly mode, and a crane/jib arm mode to choose a corresponding camera being employed for capturing. Therefore, the shooting angle is automatically created in responsive to the camera in the scene through the timeline. In addition, all the shooting angles of the cameras are shown on a screen to be selected and previewed such that it is useful for live switching, editing and scene construction.

(3.4) Set a movement of the animated character in the scene in responsive to the timeline.

(3.5) Import a dialog track in responsive to the timeline, wherein corrected mouth shapes of the animated character are automatically determined to match with phonetic transcription of the dialog track. Accordingly, the canvassing processor 20 comprises an audio recorder 21 importing a dialog track in responsive to the timeline.

The step (3) further comprises a step of creating a stereoscopic imaging effect via a stereoscopic generator to create a dual-view on the scene so as to create an illusion of depth in the scene.

Accordingly, the canvas is where, visually, the action happens. The workspace lives here and the tools around the workspace make up the canvas. In other words, the user is able to place the animated character, props, lights, cameras and create the action in the workspace.

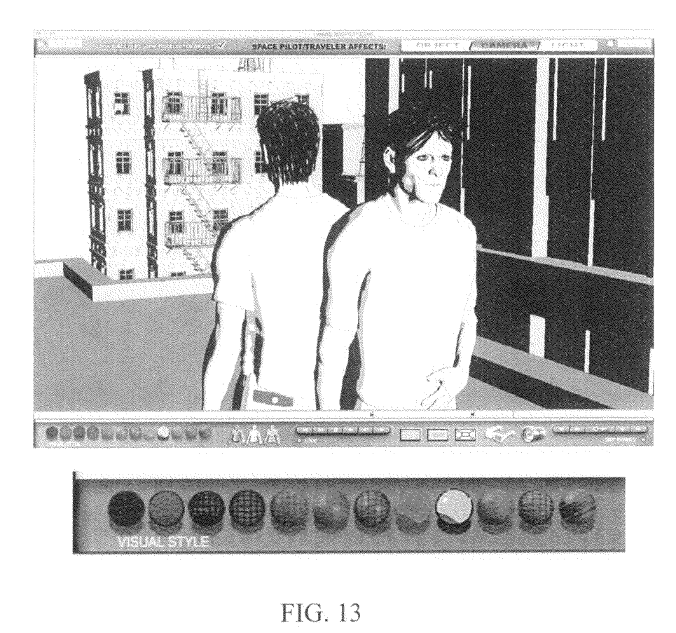

The canvassing processor provides several tools to canvas the animated video, including visual style and render helper, as shown in FIG. 13.

The visual style is used to determine the “look” of the piece. The user is able to select the display in cartoon-shaded style, wireframe, flat-shaded, fully textured and so on. The user can select any look at anytime without permanently affecting the scene.

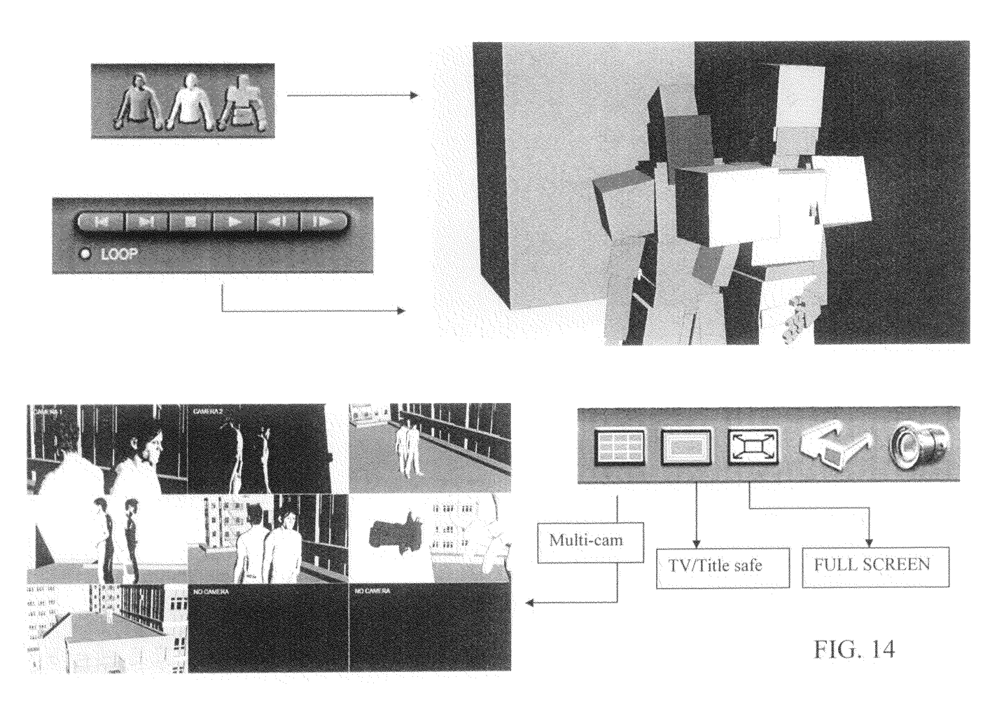

Depending on the speed of the computer, the user may experience less-than realtime playback of the scene. The render helper can be used to remove some scene detail, allowing the scene to return to realtime playback. Later, when the scene is completely finished, the render helper can be turned off and the scene will render fully with all detail restored. For example, the animated character can be displayed with the “bounding box” render helper activated, as shown in FIG. 14.

As shown in FIG. 14, the render helper contains a playback controls, including play, pause, head/tail jump and frame stepping control. The playback controls further contains five tools for different configurations. The first tool is “Multi-cam” showing the user all views that the created cameras can see. This view is usefully for live switching, editing and scene construction. The second tool toggles the “TV/Title safe” marks on and off. This can be helpful if your scene is part of final piece that will be on TV. The third tool is the “Full Screen” button so that the user can watch the scene unfettered by toolbars and overlays. Play/Stop toggle using the spacebar.

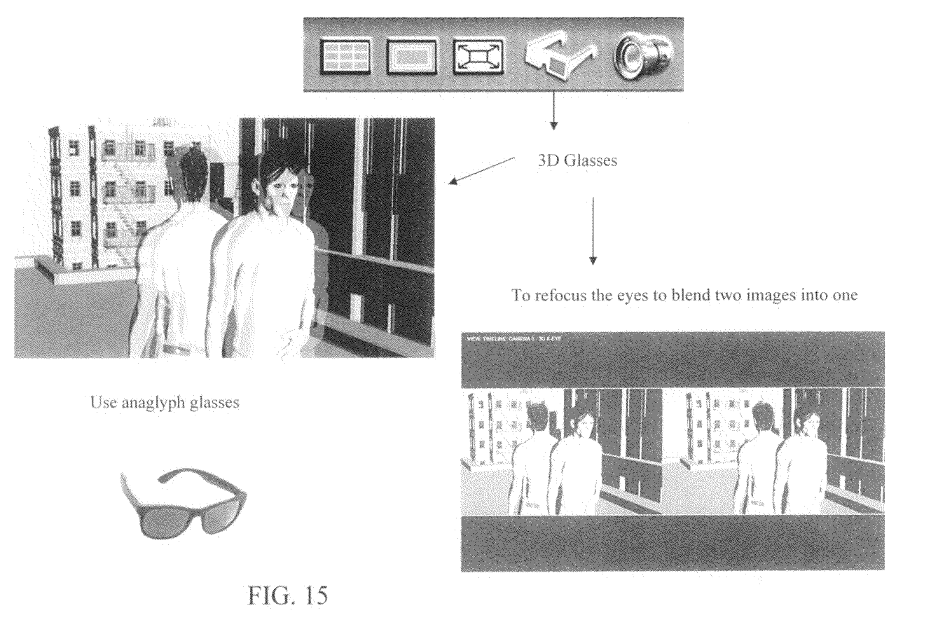

As shown in FIG. 15, the fourth tool is the “3D Glasses”. The user can select from three different 3D views. When working in CG, stereoscopic output is achieved easily by having a secondary camera paired and offset by 2.75 inches from whatever camera is achieve. This dual view can be output in a variety of ways as well as being monitored as you go. As the user is creating the scene he or she may want to keep three-dimensional viewing in mind by monitoring it in 3D. This feature is encouraged by the inclusion of a pair of plastic anaglyph glasses. Accordingly, more difficult to master is the cross-eyed technique. The user must learn how to refocus the eyes to blend two images into one. This is useful in avoiding the distortion of the red/blue method as shown in FIG. 15.

The other method to view 3D here is through the use of shutter glasses. This view is far superior to the other methods but requires an additional piece of equipment. The user's videocard and monitor must be capable of a shutter speed refresh rate of at least 120 Hz. A small box wired between the computer and the monitor regulate and transmit to LCD glasses the information to allow them to flicker left and right so the user sees 3D.

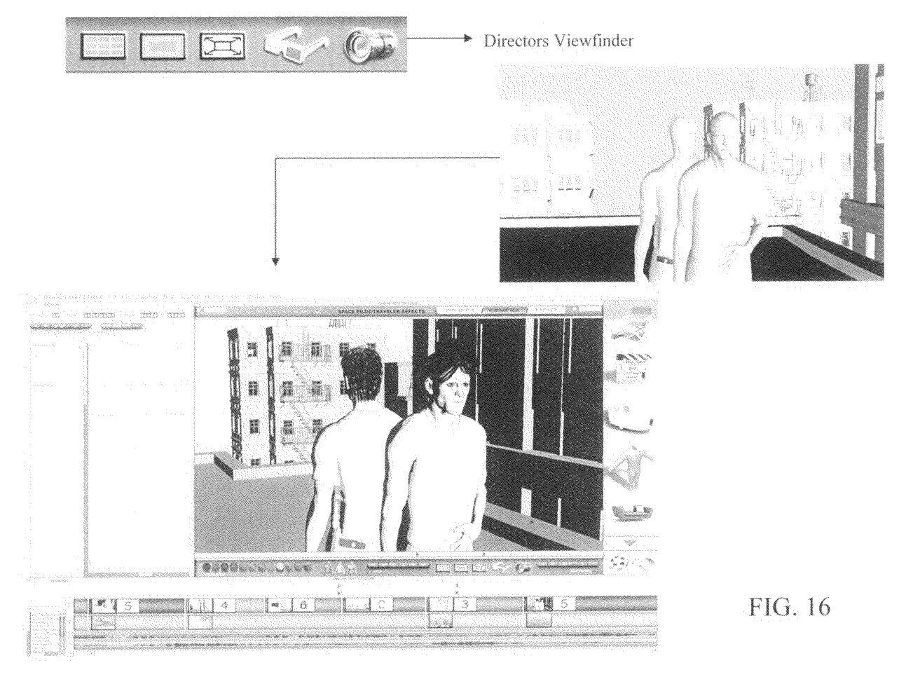

The last tool is “Directors Viewfinder”. This is used to set up the scene, place, move and animated objects and anytime the user wants to view the scene from any angle that a created camera isn't covering, as shown in FIG. 16.

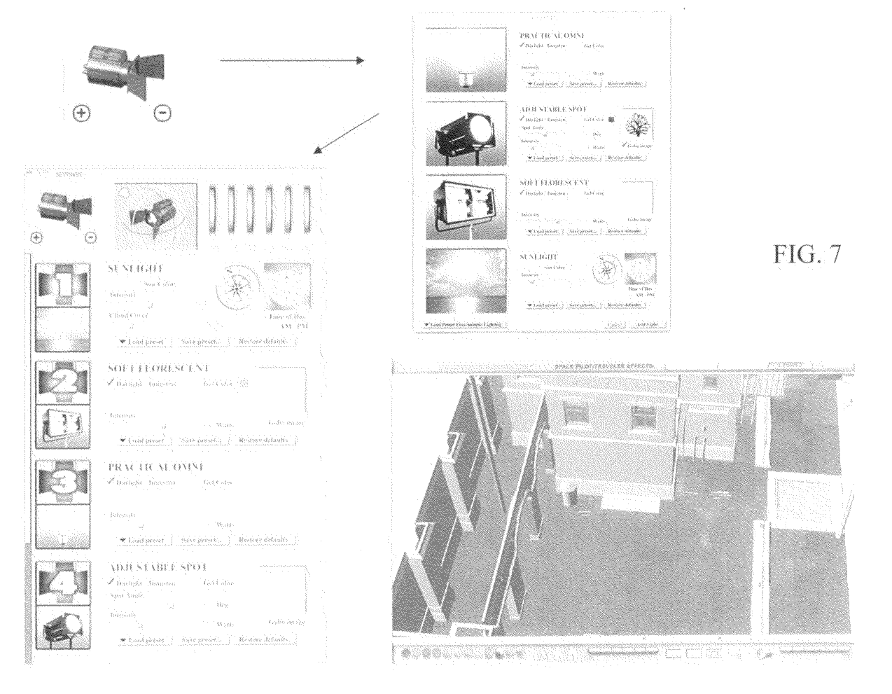

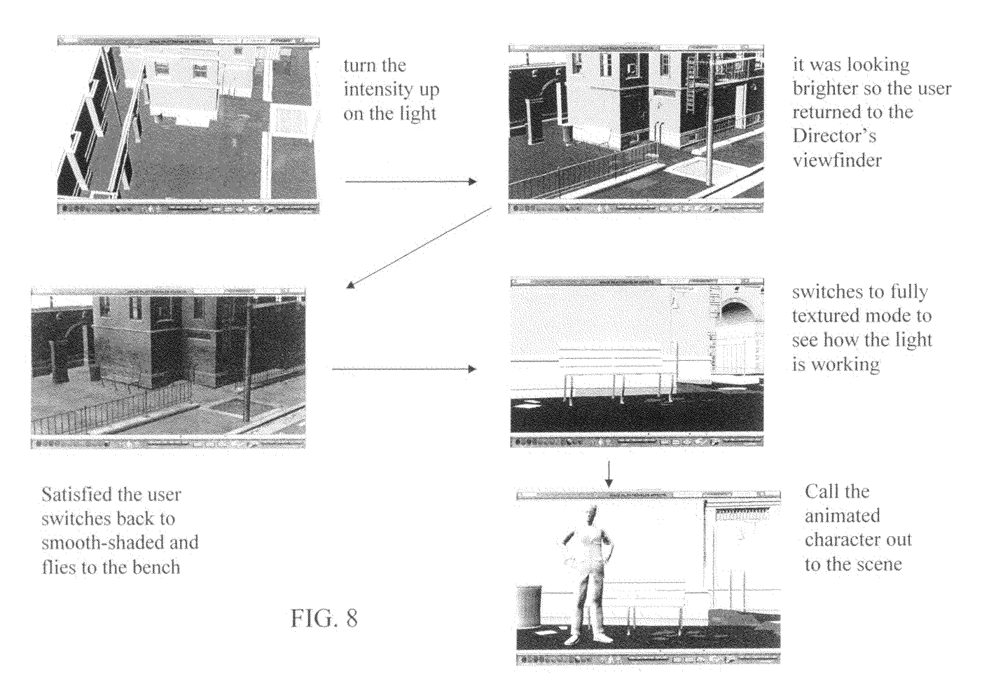

In order to light the scene, the user first selects a type of light to drop in the scene, as shown in FIG. 7. Using the 3D controller, the user is able to move and aim that light around until it has the desired effect, as shown in FIG. 8. The user may add as many as he or she likes.

While lighting, the user can switch between the director's view, seeing its effect on the environment, and the light POV, allowing easier aiming. Sunlight and Omni's will be unaffected by direction, but the 3D controller allows ease parking it in the right place in the scene.

The light set up always remains fluid. At any time the user can add more lights, remove them, move or redirect them, or even animate them over the course of the scene.

There is a lighting editor that gives the user complete control over all the lights contained in the scene. Accordingly, the selections of the lighting effect include a practical omni, an adjustable spot, soft florescent, sunlight, etc, wherein the light editor is adapted to selectively adjust the light intensity of each of the selections.

After the environment is assembled, lit and the stars are in position it is time to move them around. The user must direct them through the actions needed to complete the particular scene. Now, several techniques will come into play here simultaneously.

To get the scene right, blocking, dialog, camera and editing all must sing in unison.

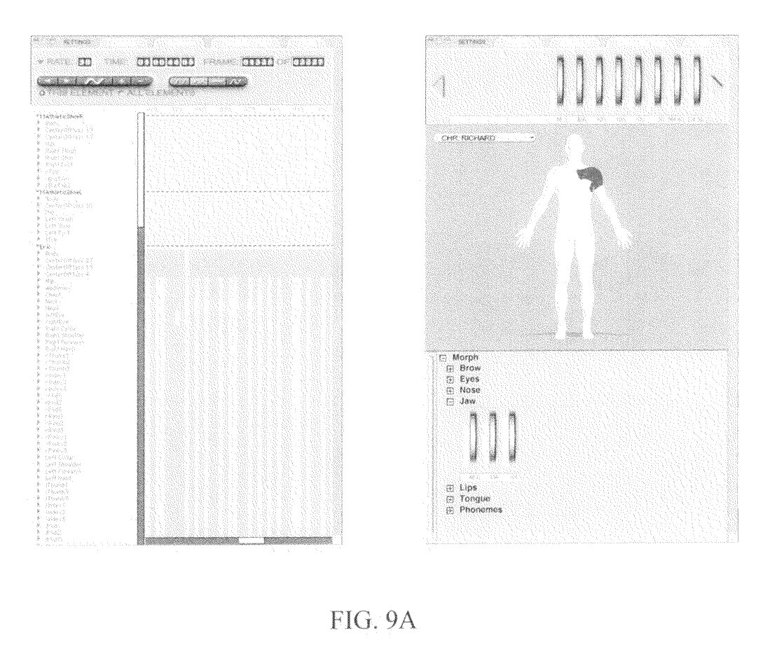

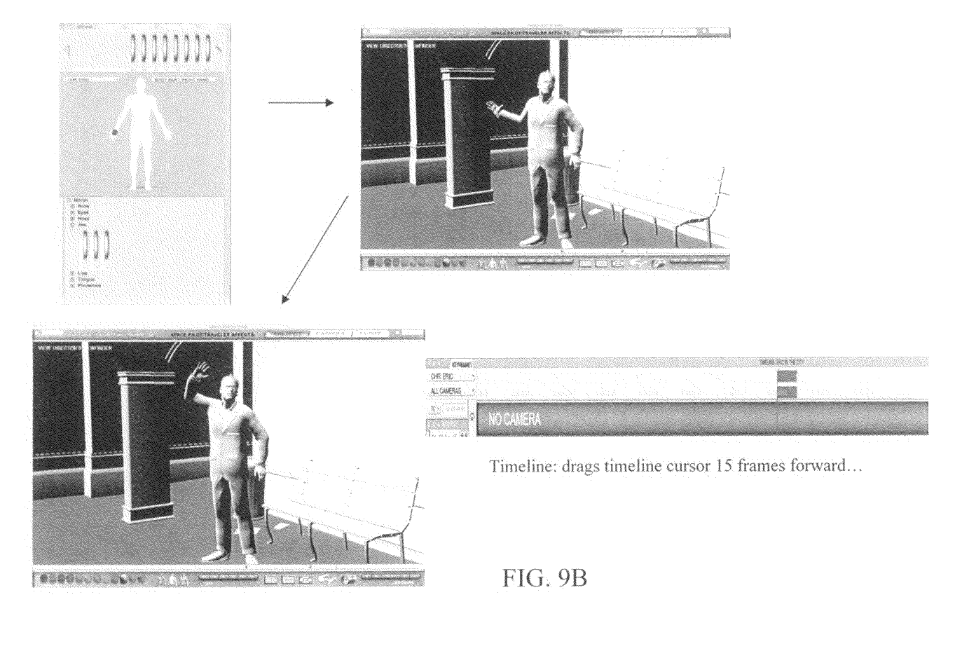

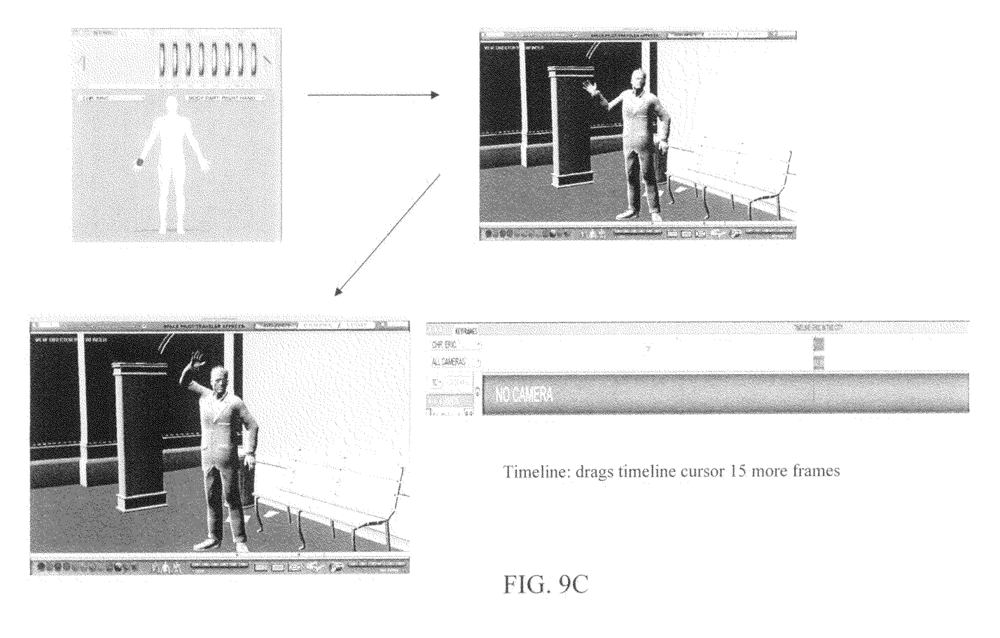

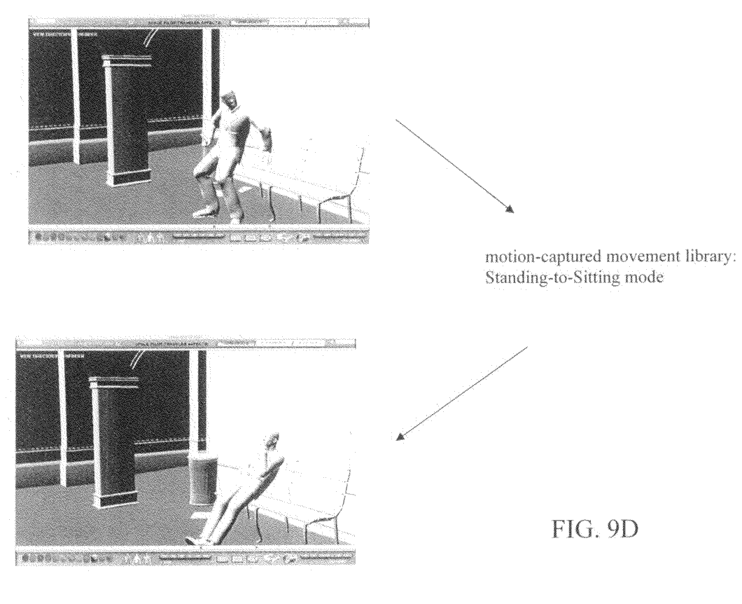

Accordingly, moving the animated character around is accomplished in several ways. As shown in FIG. 9A to 9C n order to create the movement of the animated character in the scene, the step (3.4), further comprises the following steps.

(3.4.1) Drag a body part of the animated character to move from an initial position to a final position to imitate a virtual movement of the animated character.

(3.4.2) Simulate a real human movement for the animated character in responsive to the virtual movement thereof.

Accordingly, the movement setter comprises a movement pointer dragging the body part of the animated character to move from an initial position to a final position to imitate a virtual movement of the animated character, and a movement simulator simulating the real human movement for the animated character in responsive to the virtual movement thereof.

Basic point A to point B movement requires the user to “grab” the animated character and using the 3D controller, place the animated character as desired. The user would then move ahead in the “timeline”, such as 15 seconds, and place the animated character at point B. The user will now find a “keyframe” for the animated character on the zero second mark of the timeline as well as the 15 second mark. And when the user plays the animated video, the animated character would travel from point A to point B over the course of those 15 seconds.

Alternatively, as shown in FIG. 9D, the user is able to create the movement of the animated character in the scene in the step (3.4) by the following steps.

(3.4.2) Input one or more preset natural movements to set the animated character to move from an initial position to a final position to imitate a virtual movement of the animated character.

(3.4.2) Blend the preset natural movements in order to smooth out a transition in between the preset natural movements.

(3.4.3) Simulate a real human movement for the animated character in responsive to the virtual movement thereof.

The animated character would be floating from one point to another without having a real human being moving manner. Therefore, the user is able to select a movement type from the motion-captured movement library. Perhaps a walk or run cycle is in order. These cycles are easily applied and by stitching one to the next, very natural human movement can be achieved. In-between movements are also included, such as “walk-to-run”, “run-to-jog”, run-to-halt” to help blend motions together. The user may also use the “mo-cap” blender to smooth out these transitions. The blender pairs away keyframes from adjoining ends of two mocaps allowing them to morph into each other.

The user will find plenty of animated character idles and actions that will bring the scene to life. And, as with the prop/environment online stores, so there are for motion capture. Over the years, every conceivable human motion has been captured for videogames and movies. Many of these libraries have been collected and formatted for use in the present invention. At the online stores, the user is able to buy sets of motion, complied in groups such as “cartoon actions”, “gunfighting: old west and modern”, “foot chase: wild running and leaping”.

When a pre-made motion capture is not suiting the needs, the user can drop into different places on the timeline and apply a pose from the program library, or from an online store. Applying poses to the animated character at different points on the timeline will cause the animated character to morph from one position to another over the period of that time.

And lastly, if the user is still not getting the animated character to hit the marks he or she wants them to do the actions intended, the user can manually tweak any body part at any point of the animation cycle. The user can even create the animations entirely from scratch-employing NO pre-set mocap or poses.

To directly manipulate the animated character, move the mouse over the part to grab and click it. This can be done in the director's viewport or from the chr/prop editor window. The 3D controller is now in control of this part. If the user has grabbled the animated character's shoulder, moving the 3D controller will pull the body around just as if the user were pulling a real person in the same manner. The body will react with the direction the user is giving the shoulder. For example, if the user grabbed the animated character's hand and lifted it, the arm will rise accordingly. With the present invention, mocap, poses, and direct animation with multiple levels of undo . . . the tool teaches while it creates. An amateur can perform like a seasoned vet in no time.

Having the animated characters speak is a very important part of animated video. To have the animated characters read dialog, the user must first record each animated character as a lone audio stream. This can be done through any number of audio recording programs and processor or through the basic recorder.

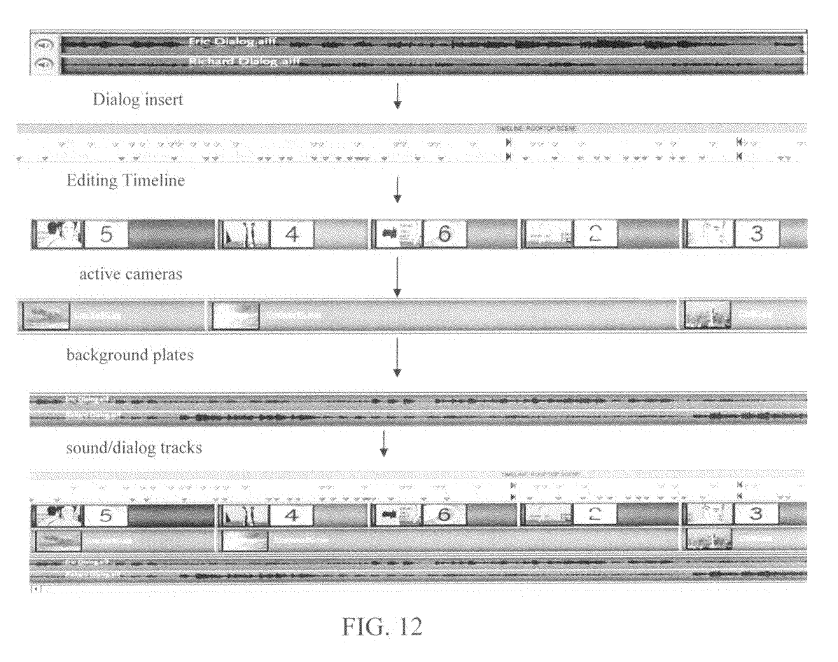

As shown in FIG. 12, once the user imports the dialog tracks they can be laid into the timeline and applied to the animated character they were created for. The user also asked to include a textual representation of the dialog on the track (from script/transcription). This helps the software determine correct mouth shapes to accomplish the sound.

The animated character will speak the dialog according to sound and text processing. This audio track can be slid around as desired until the actor is speaking his part while hitting his marks. If the user has access to facial motion capture, that too can be applied to the character but in most cases, this resource is very hard to come by.

As the user was blocking the actors through the scene, the user was creating a timeline. This is the running length of the scene the user is working on. During most of the blocking process the user is likely going to be employing the Director's Viewport which is free-floating camera aimed using the 3D controller. At some point, though, the user is going to want to create cameras to shoot the scene in a cinematic manner.

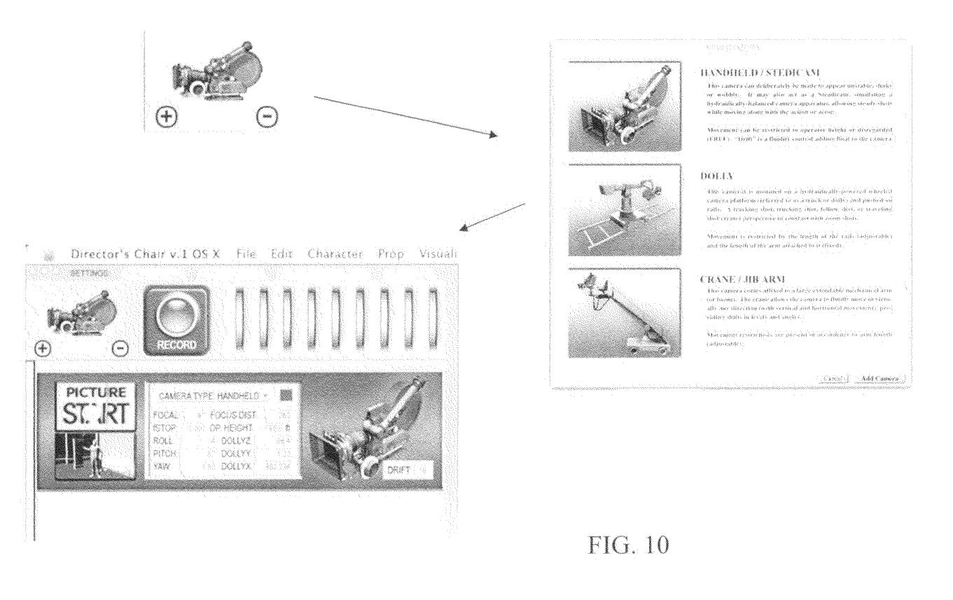

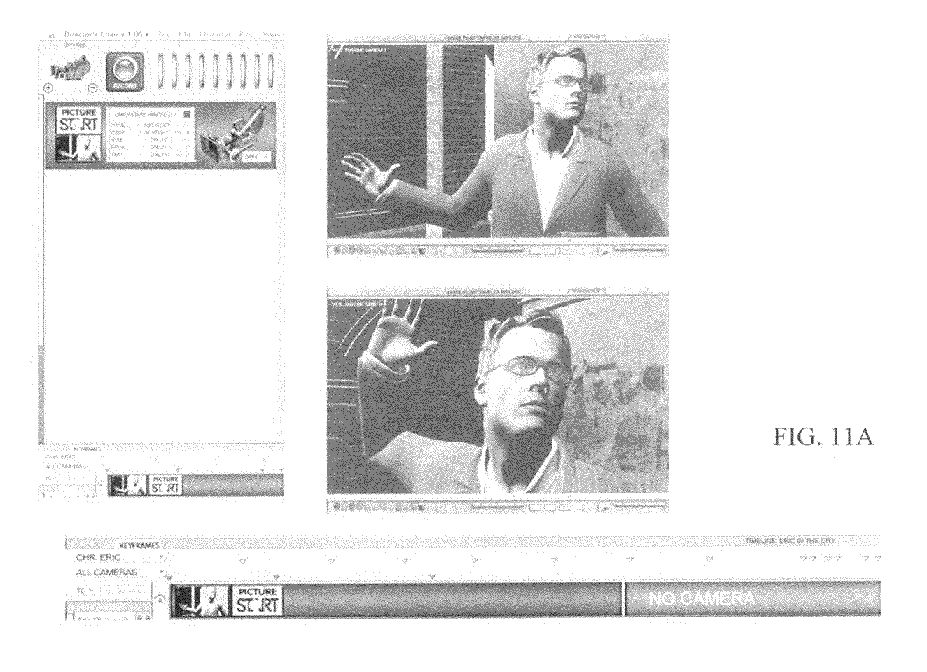

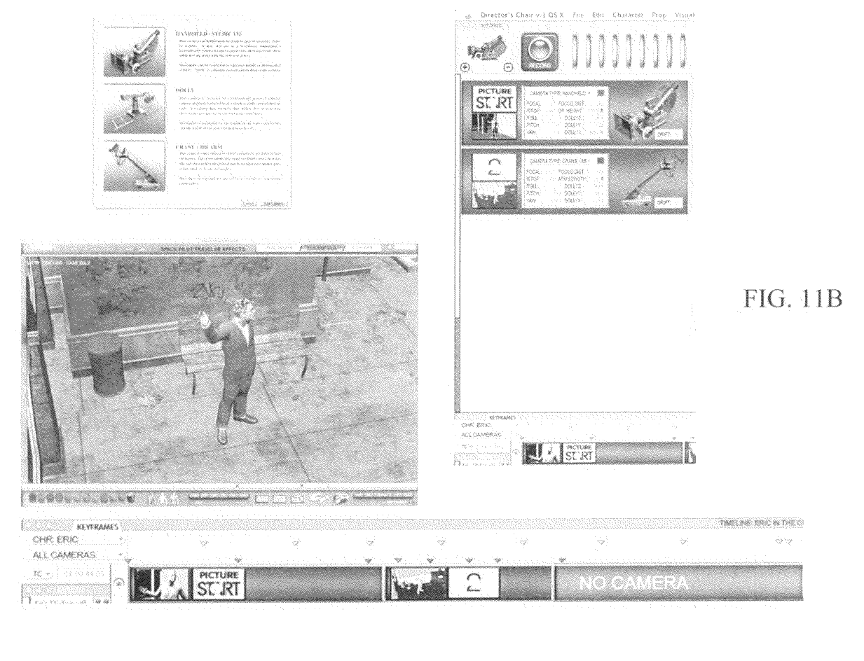

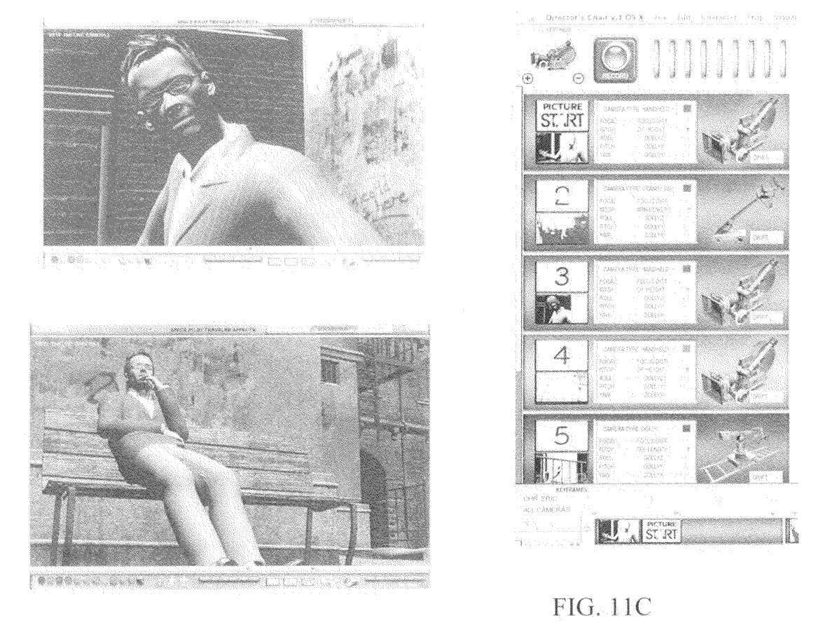

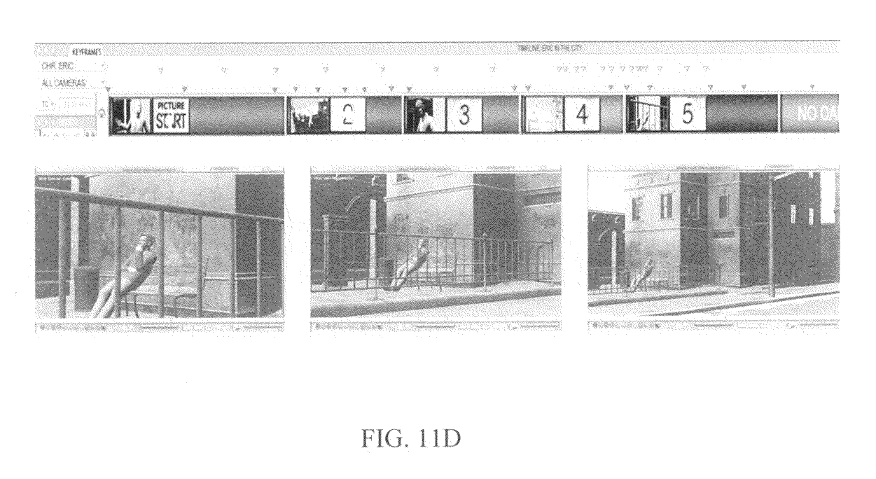

The present invention employs cameras with real-world restraints. When the user creates a new camera to shoot the scene the user is given the option to attach it to a piece of gear that restricts its movement the way that gear really would in the field. This gives animated videos a more traditional “real” feel to them as well as showing a director that is making an animatic what the user will really be able to duplicate in the field and what gear the user's going to need to do it. In the step (3.3), the shooting angle is selected by at least one of the handheld/stedicam mode, the dolly mode, and the crane/jib arm mode to choose the corresponding camera, as shown in FIGS. 10 and 11A to 11D.

Accordingly, at the handheld/stedicam mode, the camera can deliberately be made to appear unstable, shaky or wobbly. It may also act as a Steadicam, simulating a hydraulically-balanced camera apparatus, allowing steady shots while moving along with the action or actor. In addition, movement can be restricted to operator height or disregarded (free). “Drift” is a fluidity control adding float to the camera.

At the dolly mode, the camera is mounted on a hydraulically-powered wheeled camera platform (referred to as a truck or dolly) and pushed on rails. A tracking shot, trucking shot, follow shot, or traveling shot creates perspective in contrast with zoom shots. Accordingly, movement is restricted by the length of the rails (adjustable) and the length of the arm attached to it (fixed).

At the crane/jib arm mode, the camera comes affixed to a large extendable mechanical arm (or boom). The crane allows the camera to fluidity move in virtually and direction (with vertical and horizontal movement), providing shifts in levels and angles. Accordingly, movement restrictions are present in accordance to arm length (adjustable).

It the user chooses not to restrict the camera movement with real-world gear, select the handheld/steadicam. In the next phase, the user will be able to set the camera operator height to “FREE” and then fly it where the user pleases.

After a camera type is selected it goes into the bin of usable cameras, the Camera Editor. Here, all the parameters of the camera are adjustable dynamically. The camera editor shows all the cameras available for the director to employ to film the scene. As the user adds more the list becomes scrollable. Within each camera portal is panel that lists and controls that camera's properties.

Focal length, f-stop, focus distance, roll, pitch, yaw, and dolly X, Y, Z are adjustable here as well as gear-specific controls such as steadicam operator height, jib arm length and dolly track length. “Drift” refers to the amount of float the camera employs when in motion and coming to a stop from motion. Thus, an updated view is updated regularly showing what the camera is seeing at the point in the scene the operator is parked.

The camera is also assigned a unique color and number so it can easily be distinguished in the timeline.

Once a camera lives in the editor it also lives in the scene. The camera can be flown around in the scene using the 3D controller. It can be aimed anywhere and used to capture the cinematic views that make the scene look like a real movie. It can also be animated in the same way an animated character, light or prop is animated. Using keyframes the user can choose to jump to various places in the timeline and set a keyframe for the camera. Once a sequence of keyframes is created, the camera will smoothly move from one position to the next as the scene plays out. If the user develops a steady hand, the user may also choose to “shoot the scene live”. This involves a recorded path created with the 3D controller as the scene plays out. Keyframes are automatically generated during this procedure and are fully editable after the move is completed.

Accordingly, a lot of things go on here in the timelines. It is the blueprint for the scene and should be thought of as a live switcher rather than a traditional edit list of pre-existing footage.

There are timecode for position reference and the specific position marker, ii/out points (standard editing convention), keyframe positions of cameras and/or character, active cameras, background plates, and sound/dialog tracks.

The cameras the user has created are positioned (and/or animated) within the workspace and then told when to be “active” from the editing timeline. The timeline features drag and drop from the camera editor and/or selection of camera directly. Once a camera exists on the timeline the user can click on it and change it to a different camera, the user can slide edit points around and the user can insert new edit points just by “slicing” into one of them. When the user plays the scene, the position marker moves along the timeline, the actors perform the move the user blocked them to do, the soundtrack/dialog the user assigned is heard and the cameras switch according to the template the user layout here, as shown in FIG. 12.

In most cases, using a scene with animated cameras, a “cyclorama” would need to be employed to create a background that a camera can shoot from many angles. But in some cases, such as fixed camera or comic or storyboard uses, a background plate can be employed. The background plate refers to a still image or video/animation that can occupy the “negative space” where objects are not present. A common example of something that would appear here are sunsets, skylines, or “rear-screen projection” backdrops (where the animated character appears to be within a pre-existing movie).

The present invention also provides a non-linear control to allow the user to edit any feature at any point. With so much control and options, the user can see how dropping into different stages at any time would be useful. With the present invention, that way of working is expected and encouraged. Once the user becomes satisfied with the way the animated characters are moving and being filmed, the user may decide that they are not lit to the liking or that the clothing the user chose isn't good enough or that the user leading man needs a different haircut. All of these issues can be addressed without needing to re-build the scene. Any element can be substituted or edited at any time, seamlessly integrating into the final scene.

Once the user is happy with the scene the realtime playback can have the level of detail greatly increased by “rendering” it. Here the computer can take several seconds or even minutes creating each frame and thereby do a far better job with lighting, textures and shadows. The user also has the option of outputting the render as two movies-left eye and right eye, for stereoscopic finishing. The scenes the user output from here can be taken into an editing program like “Apple's Final Cut Pro” or “Avid's Media Composer” and strung together as a movie and traditionally edited.

While the applications for the present invention are vast, for the sake of this mini-tutorial let's assume that the user wants to create a short movie scene. The following example illustrates how to make an animated video through the present invention.

The director, i.e. the user, will begin with the slate. The user will fill out pertinent information such as name of the second and so forth. The user will cast the animated character and scene wherein the animated character is named as “Eric” and the scene is set “Eric” in a downtown city street, standing in front of a bench. In addition, Eric will wave to an unseen friend and then sit down on the bench.

The user will set the aspect ratio and output preferences. The aspect ratio can be 4:3, 16:9 (widescreen), or 2.35:1 (anamorphic). These can be changed at anytime. Then, the user will move into casting. The user will choose the information of the animated character, as shown in FIG. 3, wherein Eric's full name is Eric Pillman and he is a human. He is a male. He is about 5′8″ and 30 years old. After the information is set, Eric will go to the “plastic surgeon”, as shown in FIG. 4. The user is able to make Eric taller, shorter, slimmer or buffer. Accordingly, the user decides the body shape of Eric is fine but wants to make slight changes to the face of Eric. From a slew of different faces shapes, the user chooses two. Then, the user morphs one into the other using a slider. The user makes minor changes to the face and then sends Eric to the “Hair and Make-up Truck”.

Accordingly, the user could have sent Eric to Wardrobe first but the user chose to see Eric with hair before dressing him. From a multitude of hairstyles (“wigs”), the user chooses something to his liking. Then, the user adjusts color and highlight sliders to get the tone the user imagined Eric to have, as shown in FIG. 5.

Next, it is off to Wardrobe with Eric. The user thumbs through plenty of clothing choices for Eric and item at a time, dresses him up as shown in FIG. 5. The user could also go online for more clothing. At the time when the user dresses up Eric, the user is able to choose the props from the wardrobe database 13. After Eric is dressed up, Eric is saved in the trailer and is ready to be called to set.

Accordingly, the scene database 12 comes with many pre-scouted locations and set to film in. Again, the user could go online and download many varied sets and locations but the user finds an urban sprawl to his liking. Its fits the scene the user had in mind from the get-go. The user selects it and the environment loads into the workspace canvas.

The set appears in the workspace as seen from the Director's viewfinder. Using the 3D controller (and continually for most of the operations) the user files into the environment and locates a bench where the scene will be set. The scene came loaded with a light-set in place, as shown in FIG. 6. But when the user found the bench, looking at the frame fully textured and shaded, the user found it too dark. So, in order to improve the illumination where the user intends to make the action happens, the user adds a new light from the light editor tab, as shown in FIG. 7. The user picks an adjustable sport, unchecks the gobo image and sets the Gel Color to a sunny yellow. The user clicks “Add Light” and it appears in the scene (and is added to the light editor). Again, using the 3D controller, the user begins the light placement by jumping into the light's POV and flying it around the environment. The user files up to the bench and backs up towards the sky so as to look down on it (simulating a street lamp). Then, the user turned the intensity up on the light and it was looking brighter so that the user returned to the Director's viewfinder. The user switches to fully textured mode to see how the light is working. The user switches back to smooth-shaded and files to the bench, as shown in FIG. 8.

After the light effect is set, the user is able to click on the cast trailer to call out Eric. Accordingly, Eric appears in front of the bench. The user also puts Eric in a starting pose from a menu of presets, as shown in FIG. 8.

Then the user begins to animate Eric. The user could choose to apply a “waving” motion capture from the motion collections but for this example scene, the user opts to animate Eric manually. The user backs the Director's view out to a comfortable distance and grabs Eric by the hand. The editor switches to blocking mode (Character/Prop Editor). The user can click on the body part from the editor or click on Eric's hand on the canvas, as shown in FIG. 9B. The user clicks on Eric directly and the 3D controller is now moving the body part that the user pulls Eric's hand out to the side to begin the wave, takes his hand and brings it up to his head as shown in FIG. 9C. Accordingly, the user drags the timeline cursor 15 frame forward. Then, the user grabs the hand again and drags it back down towards the waist of Eric. Then, it jumps ahead 15 more frames (note Eric's keyframe on frame 15) and it pulls the hand back up towards the head. Next, the user moves ahead in the timeline again and, instead of hand animating Eric into a sitting position, the user selects a “Standing-to-Sitting” motion capture from the movement library, as shown in FIG. 9D. The user sets a duration for the motion, a blend duration and then applies this to Eric. As the user scrolls through the timeline the user can see Eric taking a seat.

Accordingly, the user is able to edit the animated video at any point. The user conceives a few shot that will make the animated video better. The user floats around using the Director's Glass to look at the scene from many angles that the user clicks on the camera editor tab and presses the “create” new camera button, as shown in FIG. 10. This opens a new window where the user can select from three different camera types: Handheld/Stedicam, Dolly and Crane/Jib Arm.

As shown in FIG. 11A, the user chooses a handheld camera so that the user can have freedom to move where he pleases. The user can always apply equipment restrictions in the camera editor. Later, as the user gets the rhythm going he might choose a restricted camera initially. Once the user chooses the camera appeared in the workspace, randomly pointed, and the camera editor. Accordingly, setting the operator height to “Free” allows the user to fly the camera anywhere in the workspace.

The camera is dragged into the timeline and the user flies up to Eric and sets a keyframe frame 0. The user then moves forward in the timeline (as Eric ‘acts’ according to the user's direction.), moves the camera and sets another keyframe two seconds later. The user can now see the camera move from point A to point B while Eric waves.

The user decides that midway though the shot the camera doesn't track the way the user would like, so on frame 21 the user adds another keyframe and repositions the camera slightly. Now the camera moves from Point A to B to C. The camera currently stops moving at about frame 50 even though the edit is at the 3 second mark (randomly). The user is going to switch to another camera before frame 50 so the user is not worried about a sudden stop.

Next, the user creates another camera as shown in FIG. 11B. The user wants to be high up looking down on the action so the user chooses a Crane/Jib camera. It drops into the camera editor and the user drags it into the timeline.

The user drags the edit back to frame 48, so that Camera 1 is still in motion when the user cuts to Camera 2. The user views the canvas through Camera 2, places a keyframe at frame 43 (positioning it at a pleasing angle) and skips ahead a couple seconds and keyframes the camera in a slightly different position to create a subtle move over the course of the shot. Watching the playback, the user decides a couple more keyframes would give the cam a more “human” look. The user also ends the shot at frame 81, just before the final keyframed camera position-frame 83. Accordingly, as shown in FIG. 11C, the user creates three more cameras and goes through the same workflow: putting the camera in timeline, keyframing action points for those cameras and setting edit points to switch fro one to the next.

So, by the time the user is done, there are 5 cameras floating around in the scene as shown in FIG. 11D. A scene like this could be shot with two cameras that move to their next position while we are looking through the view of the other, but it is usually easier for a filmmaker to keep track of a few more cameras with a single purpose. And that's the end of this example. A little movie was made which will, on its own, entertain very few.

Accordingly, a beginner is able to simply install the present invention into the computer such that the beginner is able to make his or her own animated movie with professional quality. In addition, the film director is able to create his or her own scene as a trial taster to see the effect while being cost effective and to allow the actor and/or actress to easily understand the theme of the scene. Furthermore, other users, such as a web designer or a businessman, are able to create the animated movie in the web site to enhance the interaction thereof.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of making an animated movie, comprising the steps of:
(a) casting one or more animated characters as performers in a play of said animated video;
(b) creating one or more scenes of said animated video, wherein said scene is populated with props;
(c) canvassing said animated character in said scene to form a motion picture, comprising the steps of:
(c.1) creating a timeline of said scene;
(c.2) setting a light effect of said scene;
(c.3) setting a shooting angle of said animated character in said scene, wherein said scene is viewed from said shooting angle through said timeline; and
(c.4) setting a movement of said animated character in said scene in responsive to said timeline; and
(d) outputting said motion picture in a realtime playback manner.

2. The method, as recited in claim 1, wherein the step (a) further comprises the steps of:
(a.1) selecting a personal information and physical characteristics of said animated character including name, age, gender, race, hair style and color, eye color, height, weight, and body shape, wherein said animated character is envisioned to be an exact person; and
(a.2) costuming said animated character wherein said animated character is outfitted in said scene.

3. The method, as recited in claim 2, wherein the step (a.1) further comprises a step of morphing two or more physical characteristics of said animated character to blend said physical characteristics together.

4. The method, as recited in claim 1, wherein the step (c) further comprises a steps of importing a dialog track in responsive to said timeline, wherein corrected mouth shapes of said animated character are automatically determined to match with phonetic transcription of said dialog track.

5. The method, as recited in claim 3, wherein the step (c) further comprises a steps of importing a dialog track in responsive to said timeline, wherein corrected mouth shapes of said animated character are automatically determined to match with phonetic transcription of said dialog track.

6. The method as recited in claim 4 wherein, in the step (c.3), said shooting angle is selected by at least one of a handheld/stedicam mode, a dolly mode, and a crane/jib arm mode to choose a corresponding camera being employed for capturing, wherein said shooting angle is automatically created in responsive to said camera in said scene through said timeline.

7. The method as recited in claim 5 wherein, in the step (c.3), said shooting angle is selected by at least one of a handheld/stedicam mode, a dolly mode, and a crane/jib arm mode to choose a corresponding camera being employed for capturing, wherein said shooting angle is automatically created in responsive to said camera in said scene through said timeline.

8. The method as recited in claim 6 wherein, in the step (c.3), said shooting angles of said cameras are shown on a screen to be selected and previewed for scene construction.

9. The method as recited in claim 7 wherein, in the step (c.3), said shooting angles of said cameras are shown on a screen to be selected and previewed for scene construction.

10. The method as recited in claim 1 wherein, in the step (c.4), further comprises the steps of:
(c.4.1) dragging a body part of said animated character to move from an initial position to a final position to imitate a virtual movement of said animated character; and
(c.4.2) simulating a real human movement for said animated character in responsive to said virtual movement thereof.

11. The method as recited in claim 9 wherein, in the step (c.4), further comprises the steps of:
(c.4.1) dragging a body part of said animated character to move from an initial position to a final position to imitate a virtual movement of said animated character; and
(c.4.2) simulating a real human movement for said animated character in responsive to said virtual movement thereof.

12. The method as recited in claim 1 wherein, in the step (c.4), further comprises the steps of:
(c.4.1) inputting one or more preset natural movement types to set said animated character to move from an initial position to a final position to imitate a virtual movement of said animated character;
(c.4.2) blending said preset natural movement types in order to smooth out a transition in between said preset natural movement types; and
(c.4.3) simulating a real human movement for said animated character in responsive to said virtual movement thereof.

13. The method as recited in claim 9 wherein, in the step (c.4), further comprises the steps of:
(c.4.1) inputting one or more preset natural movement types to set said animated character to move from an initial position to a final position to imitate a virtual movement of said animated character;
(c.4.2) blending said preset natural movement types in order to smooth out a transition in between said preset natural movement types; and
(c.4.3) simulating a real human movement for said animated character in responsive to said virtual movement thereof.

14. The method, as recited in claim 1, wherein the step (c) further comprises a step of creating a stereoscopic imaging effect to create a dual-view on said scene so as to create an illusion of depth in said scene.

15. The method, as recited in claim 11, wherein the step (c) further comprises a step of creating a stereoscopic imaging effect to create a dual-view on said scene so as to create an illusion of depth in said scene.

16. The method, as recited in claim 13, wherein the step (c) further comprises a step of creating a stereoscopic imaging effect to create a dual-view on said scene so as to create an illusion of depth in said scene.

17. The method as recited in claim 14, wherein an anaglyph glasses is used to view said stereoscopic imaging effect on said scene.

18. The method as recited in claim 15, wherein an anaglyph glasses is used to view said stereoscopic imaging effect on said scene.

19. The method as recited in claim 16, wherein an anaglyph glasses is used to view said stereoscopic imaging effect on said scene.

20. An animated video making system, comprising:
a central database containing a casting database containing a plurality of animated characters to be selected as a performer in a play of an animated video, a scene database containing a plurality of scenes to be selectively created for said animated video and a plurality of props to be selected to populate said scene with said props, and a wardrobe database containing a plurality of costumes to be selected for costuming said animated character such that said animated character is outfitted in said scene;
a canvassing processor operatively canvassing said animated character in said scene to form a motion picture, wherein said canvassing processor comprises a timeline setter creating a timeline of said scene, a lighting setter setting a light effect of said scene, a camera selector selectively setting a shooting angle of said animated character in said scene, and a movement setter setting a movement of said animated character in said scene in responsive to said timeline; and
a rendering processor outputting said motion picture in a realtime playback manner.

21. The animated video making system, as recited in claim 20, wherein said canvassing processor further comprises an audio recorder importing a dialog track in responsive to said timeline, wherein corrected mouth shapes of said animated character are automatically determined to match with phonetic transcription of said dialog track.

22. The animated video making system, as recited in claim 20, wherein said shooting angle is selected by at least one of a handheld/stedicam mode, a dolly mode, and a crane/jib arm mode to choose a corresponding camera being employed for capturing, wherein said shooting angle is automatically created in responsive to said camera in said scene through said timeline.

23. The animated video making system, as recited in claim 21, wherein said shooting angle is selected by at least one of a handheld/stedicam mode, a dolly mode, and a crane/jib arm mode to choose a corresponding camera being employed for capturing, wherein said shooting angle is automatically created in responsive to said camera in said scene through said timeline.

24. The animated video making system, as recited in claim 22, wherein said shooting angles of said cameras are shown on a screen to be selected and previewed for scene construction.

25. The animated video making system, as recited in claim 23, wherein said shooting angles of said cameras are shown on a screen to be selected and previewed for scene construction.

26. The animated video making system, as recited in claim 20, wherein said movement setter comprises a movement pointer dragging a body part of said animated character to move from an initial position to a final position to imitate a virtual movement of said animated character, and a movement simulator simulating a real human movement for said animated character in responsive to said virtual movement thereof.

27. The animated video making system, as recited in claim 25, wherein said movement setter comprises a movement pointer dragging a body part of said animated character to move from an initial position to a final position to imitate a virtual movement of said animated character, and a movement simulator simulating a real human movement for said animated character in responsive to said virtual movement thereof.

28. The animated video making system, as recited in claim 20, wherein said central database further contains a motion-captured movement library pre-storing a plurality of movement types to be selected to set said animated character to move from an initial position to a final position to imitate a virtual movement of said animated character, wherein said movement types are then blended to smooth out a transition thereof so as to simulate a real human movement for said animated character in responsive to said virtual movement thereof.

29. The animated video making system, as recited in claim 25, wherein said central database further contains a motion-captured movement library pre-storing a plurality of movement types to be selected to set said animated character to move from an initial position to a final position to imitate a virtual movement of said animated character, wherein said movement types are then blended to smooth out a transition thereof so as to simulate a real human movement for said animated character in responsive to said virtual movement thereof.

30. The animated video making system, as recited in claim 20, wherein said canvassing processor further comprises a stereoscopic generator generating a stereoscopic imaging effect to create a dual-view on said scene so as to create an illusion of depth in said scene and an anaglyph glasses viewing said stereoscopic imaging effect on said scene.

31. The animated video making system, as recited in claim 27, wherein said canvassing processor further comprises a stereoscopic generator generating a stereoscopic imaging effect to create a dual-view on said scene so as to create an illusion of depth in said scene and an anaglyph glasses viewing said stereoscopic imaging effect on said scene.

32. The animated video making system, as recited in claim 29, wherein said canvassing processor further comprises a stereoscopic generator generating a stereoscopic imaging effect to create a dual-view on said scene so as to create an illusion of depth in said scene and an anaglyph glasses viewing said stereoscopic imaging effect on said scene.
